(19) United States
(12) Patent Application Publication
(10) Pub. No.: US 2004/0031446 A1
(43) Pub. Date: Feb. 19, 2004

(54) MODULAR ANIMAL HOLDING SYSTEM

(76) Inventor: Irvin A. Harrison, Houston, TX (US)

Correspondence Address: Mark R. Wisner, Wisner & Associates, 1177 West Loop South, Suite 400, Houston, TX, 77027-9012, US

(21) Appl. No.: 10/223,447

(22) Filed: Aug. 19, 2002

(51) Int. Cl. A01K 1/03; A01K 31/06

(52) U.S. Cl. 119/480

(57) ABSTRACT

A modular kennel system, each module including a floor tub having a sloped floor and a gutter formed therein that is supported at a level above the surface on which the system rests for draining wastes therefrom. The system is erected on site without modification of the site in a variety of configurations and sizes and with or without a second level of enclosures. Each module comprising the system includes a substantially vertical panel from which the floor tub is supported and the drain basin formed in the gutter of the floor tub is connected through a plumbing trap to a drainpipe that runs between the module and the next adjacent module to connect the drain basins of the gutters from successive modules. This structure of the modular kennel system prevents cross-contamination, including sewer gases, between enclosures. The system may also include manual, timed, or conductivity-controlled flush systems for ridding the enclosures of waste fluids under a grate that is easy to clean. The kennel system may also include a ventilation system for insuring fresh air in the enclosure(s) in each module. Flushing and ventilation provides a healthy, dry environment for the animals housed within the enclosures comprising the modular kennel system.

### BACKGROUND OF THE INVENTION

The present invention relates to a modular kennel system. In more detail, the present invention relates to a kennel including multiple enclosures that is constructed in a variety of configurations and with a desired number of enclosures from a minimal number of parts. The modular kennel system is “self-contained,” and in one embodiment, the system includes all the necessary plumbing components for automatic flushing of the enclosures comprising the kennel system and can be erected on-site, without modification of the site, at any site with an existing exit drain, regardless of whether that site is inside a building or other structure. The construction of the modular kennel system of the present invention is such that it can be erected on-site but also disassembled and re-located to another site with relative ease.

Many animal cages and enclosures are known in the patent literature and/or available commercially. Reference can be made, for instance, to U.S. Pat. Nos. 4,794,879, 5,116,256, 5,482,005, 6,021,739 disclosing such cages. Animal cages and enclosures are available commercially from such vendors as Mason Fence Co. (Leesburg, Ohio), Suburban Surgical Company, Inc. (Wheeling, Ill.), Schroer Manufacturing Company (Kansas City, Mo.), and T Kennel Systems, Inc. (Kansas City, Mo.), and some of these vendors claim to provide custom-designed enclosures that can be built on-site so as to house small animals such as dogs and cats. Some such multi-cage kennels, such as the Mason DOUBLE D modular kennel system, can even be double-decked so as to better utilize available space in facilities for housing small animals.

However, such kennels are characterized by a number of disadvantages and limitations. For instance, most such kennels are not equipped with automated flush system equipment such that they require manual cleaning. Some kennels, such as the stainless steel pens available from Suburban Surgical, the T Kennel design available from T Kennel Systems, Inc., and the SHOR-LINE kennel runs and drain kennels available from Schroer Manufacturing Company, are provided with raised floors that are sloped with a drain at the low end of the sloped floor that are intended to be sprayed with water so as to wash down animal waste so as to minimize the need for manual pick up and cleaning. At least one of those systems, the drain kennels available from Schroer Manufacturing Company, also provides connections from the drain in each kennel to a drainpipe that runs from kennel to kennel. The others must be erected, or require modification of the building in which they are erected, so that the waste can be washed from out of the cages and subsequently out of the building by draining into a gutter or sump under the cages so that waste that is washed out of the cages can then be flushed from the sump. In spite of such claims by their manufacturers, neither the drain kennels available from Schroer Manufacturing or any of the other manufacturers, nor the type of cages that drain into a gutter or sump, are effective at preventing cross-contamination between kennels.

Another limitation of such kennels is their relatively high cost. The cost results from a number of factors, including the need for a special, or single-purpose, building or a building that is modified for erection of the kennels. Other factors that increase the cost of such kennels include, for instance, their lack of flexibility. Although they are advertised as being available in custom lengths and sizes, known commercially-available kennels are available in a limited number of sizes such that they cannot always be optimally situated in the building. Because they are available in a limited number of dimensions, one can only try to fit as many cages as possible into the building while maintaining a mix of cage sizes that will be adequate for the range of sizes of animals that must be maintained in the cages.

It is, therefore, a primary object of the present invention to provide a modular kennel comprising at least two modules, each module comprising a pair of substantially vertical panels and a pair of substantially horizontal, substantially rectangular floor tubs, each of the floor tubs being supported from a respective panel and having a gutter formed therein that slopes from one end of the floor tub to the other end of the floor tub. The floor tubs are oriented relative to each other so that the low ends of each of the gutters are proximate each other. The modular kennel also includes a drainpipe running between each of the two modules to which the low ends of the gutters of each of the floor tubs comprising the modules are connected and, in one embodiment, plumbing traps are provided in the connections to prevent cross-contamination from enclosure to enclosure.

Another object of the present invention is to provide a modular kennel system that is self-flushing and/or that can be washed down with water that does not require modification of the building or site on which it is erected to provide drainage of the cages comprising the kennel system.

Another object of the present invention is to provide a modular kennel system including cage enclosures that can be provided with floor grates and an automatic flush system that keeps the animal housed within the enclosure healthy and dry.

It is another object of the present invention to provide a floor tub for an animal cage comprising a substantially rectangular panel having a lip formed around the edge thereof and having a gutter formed in the surface thereof and running in the direction of the long dimension of the pane, the gutter being deeper at one end of the panel than the other end, and the surface of the panel being sloped downwardly from the lip to the gutter.

Yet another object of the present invention is to provide a kennel system that includes enclosures that are available in a wide range of sizes so as to allow optimal use of the space in which the system is erected.

Another object of the present invention is to provide a bi-level kennel system that maximizes the use of available space for erection of the system.

Another object of the present invention is to provide a bi-level kennel system that provides safe, convenient walkways for access to the enclosures on both levels of the kennel system without lifting the animals for entry or exit from the enclosures.

Another object of the present invention is to provide a kennel system that provides effective ventilation of the enclosures comprising the system.

There are other objects, and many advantages, of the modular kennel system of the present invention that will be made clear to those skilled in the art by the following description of the presently preferred embodiments of the invention. This listing of several of the objects to which the invention is directed is provided merely to illustrate the rationale for the present invention and is not intended as a complete listing of all of the motivations for making the present invention.

### SUMMARY OF THE INVENTION

These objects are achieved by providing a modular kennel comprising at least two modules, each module comprising:

a pair of substantially vertical panels,

a pair of substantially horizontal, substantially rectangular floor tubs, each of the floor tubs being supported from a respective panel and having a gutter formed therein that slopes from one end of the floor tub to the other end of the floor tub, the floor tubs being oriented relative to each other so that the low ends of each of the gutters are proximate each other, and

a drain pipe running between the modules to which the low ends of the gutters in each of the floor tubs comprising the modules are connected.

In another aspect, the present invention provides a floor tub for an animal enclosure that comprises a substantially rectangular panel having a lip formed around the edge thereof and a gutter formed in the surface of the panel that runs in substantially the same direction as the long dimension of the panel. The gutter is deeper at one end of the panel than the other end and the surface of the panel in which the gutter is formed is sloped downwardly from the lip to the gutter in a direction that is substantially perpendicular to the long dimension of the panel.

### BRIEF DESCRIPTION OF THE DRAWINGS

FIG. 1 is a perspective view of a presently preferred embodiment of a modular kennel system that is constructed in accordance with the teachings of the present invention that is shown without some of its component parts for purposes of clarity.

FIG. 2 of a perspective view of a single-level module of a presently preferred embodiment of a modular kennel system that is constructed in accordance with the teachings of the present invention.

FIG. 3 is a perspective view of a bi-level module of a presently preferred embodiment of a modular kennel system that is constructed in accordance with the teachings of the present invention.

FIGS. 4A and 4B are top plan and side elevational views, respectively, of a presently preferred embodiment of a floor tub comprising the floor of one module of the kennel system of FIG. 1 that is constructed in accordance with the teachings of the present invention.

FIGS. 5A and 5B are sectional views of the floor tub of FIG. 4 taken at the lines A-A and B-B, respectively, of FIG. 4A.

FIG. 6 is a bottom perspective view of the modular kennel system of FIG. 1.

FIGS. 7A and 7B are top perspective and sectional views of a second preferred embodiment of the floor tub of the present invention.

### DETAILED DESCRIPTION OF THE PREFERRED EMBODIMENT

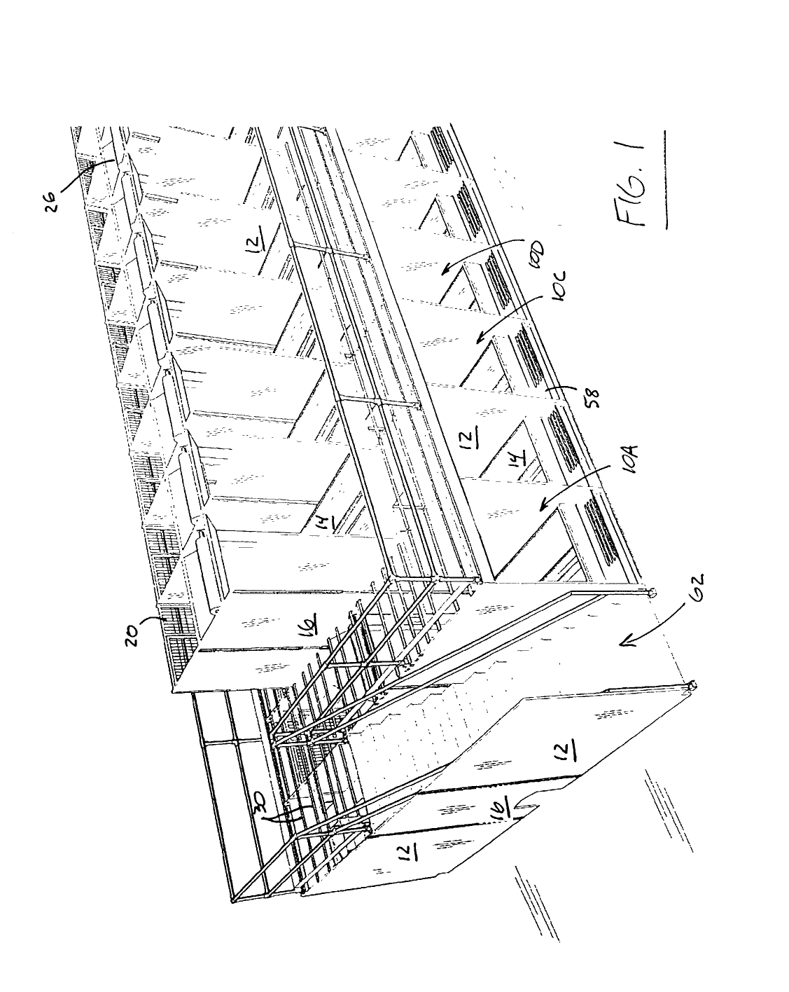

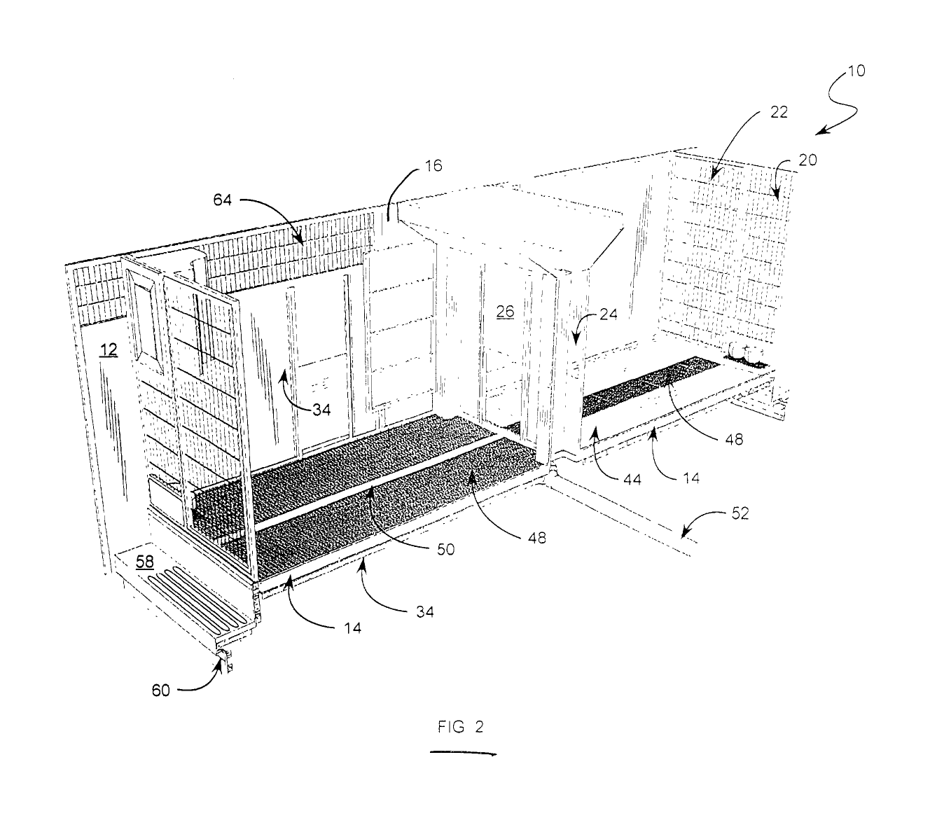

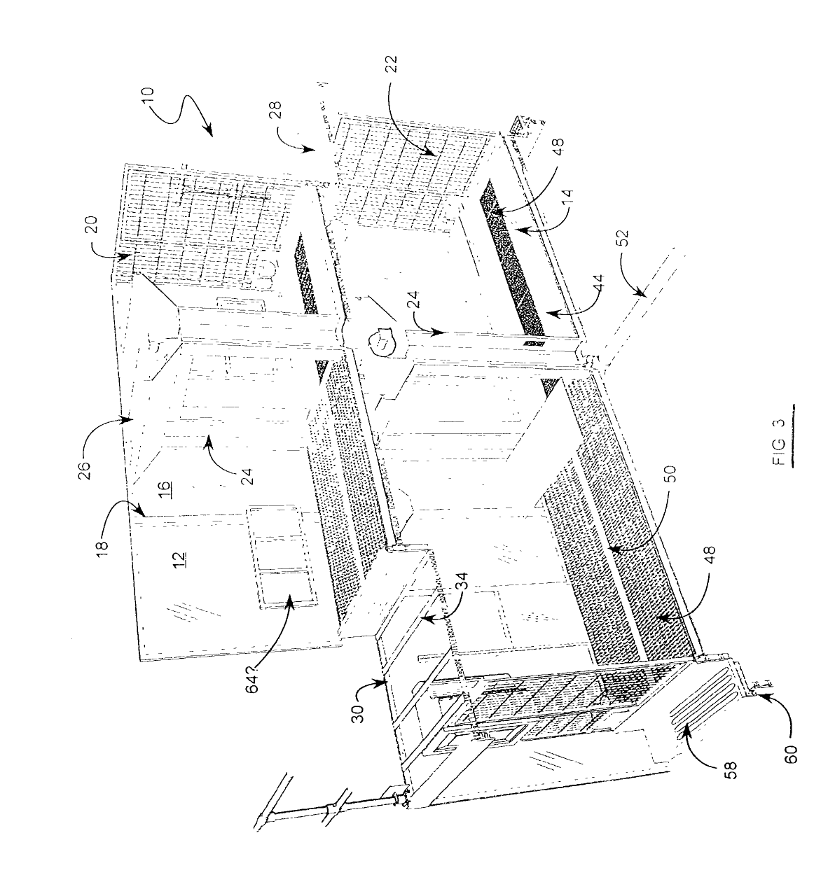

Referring to FIG. 1, there is shown a perspective view of a preferred embodiment of the modular kennel system of the present invention. The particular embodiment shown comprises at least two, and preferably a plurality of, modules 10A, 10B, 10C, etc. As best shown in FIGS. 2 and 3, each module 10 is comprised of certain component parts that are common to most, if not all, of the modules 10, including a pair of substantially vertical panels 12a and 12B and a corresponding pair of substantially horizontal floor tubs 14A and 14B, each of the floor tubs 14 being supported from a respective panel 12. For a purpose discussed below, and as will be apparent from inspection of FIGS. 2 and 3, the floor tubs 14 are supported from panels 12 at a height above the surface on which the panels 12 rest. In the particular embodiment shown, the module 10 additionally comprises a center panel 16, also substantially vertical, that is connected between the panels 12A and 12B to form a continuous wall, by a batten 18 or similar fastener(s) of a type known in the art. It will be understood by those skilled in the art who have the benefit of this disclosure that the panels 12 and 16 may be a single, continuous panel, or formed from two or any other number of panels that are connected by fasteners of any known type suitable for forming a wall to make the module 10. Although supported from the vertical panels 12, the substantially horizontal floor tubs 14 form the floor of each module 10 and, as best shown by reference to FIG. 1, are supported on both sides by the substantially vertical panels 12 of the next adjoining module 10 to define an animal cage, pen, kennel, or enclosure.

The particular module 10 shown in FIG. 2 is provided with a grill 20 forming one end of the enclosure and a door 22 forming the other end of the enclosure. The particular module 10 shown in FIG. 2 is also provided with a vertical tower 24 between the two floor tubs 14A and 14B that supports a divider door 26 that can be pulled down to divide the module 10 into two separate enclosures. It will be obvious to those skilled in the art that the grill 20 can also be a swinging door 22 so that animals can be housed in both of the enclosures comprising module 10 when the divider door 26 divides the module 10 into two separate enclosures.

Referring to FIG. 3, a bi-level module 10 is shown that is constructed of the same component parts as described in connection with the module shown in FIG. 2. The panels 12A and 12B, as well as the central panel 16, extend vertically to a dimension that is high enough to frame an upper enclosure by supporting a floor tub 14D from the panel 12B (no floor tub is shown supported from panel 12A for a purpose to be made clear below). The upper enclosure is provided with a pair of towers 14 that, like the towers 14 in FIG. 2, support a divider door 26 for dividing the upper enclosure into two enclosures in the same manner as described in connection with the module shown in FIG. 2. The upper enclosure is closed at both ends by a pair of doors 22 and/or by a door 22 and grill 20 in the same manner as described above in connection with the module shown in FIG. 2. It will also be apparent from FIG. 3 that the floor tubs 14 forming the floor of the upper enclosure are of shorter longitudinal dimension than the floor tubs forming the floor of the lower enclosure (or the single level module shown in FIG. 2), but as will be described in more detail below, the floor tubs 14 that form the floor of the upper enclosure are the same floor tubs 14 that form the floor of the lower enclosure, but have been formed to a length short enough to provide for the use of a portion of the ceiling of the lower enclosure as a walkway 28 (see FIG. 1) that is also supported from the substantially vertical panels 12A and 12B. As described in more detail below, the panels comprising walkway 28 and the floor tubs 14 are supported from the substantially vertical panels 12 by a plurality of straps 30, 32, respectively, that rest on rails 34 that are affixed to the panels 12.

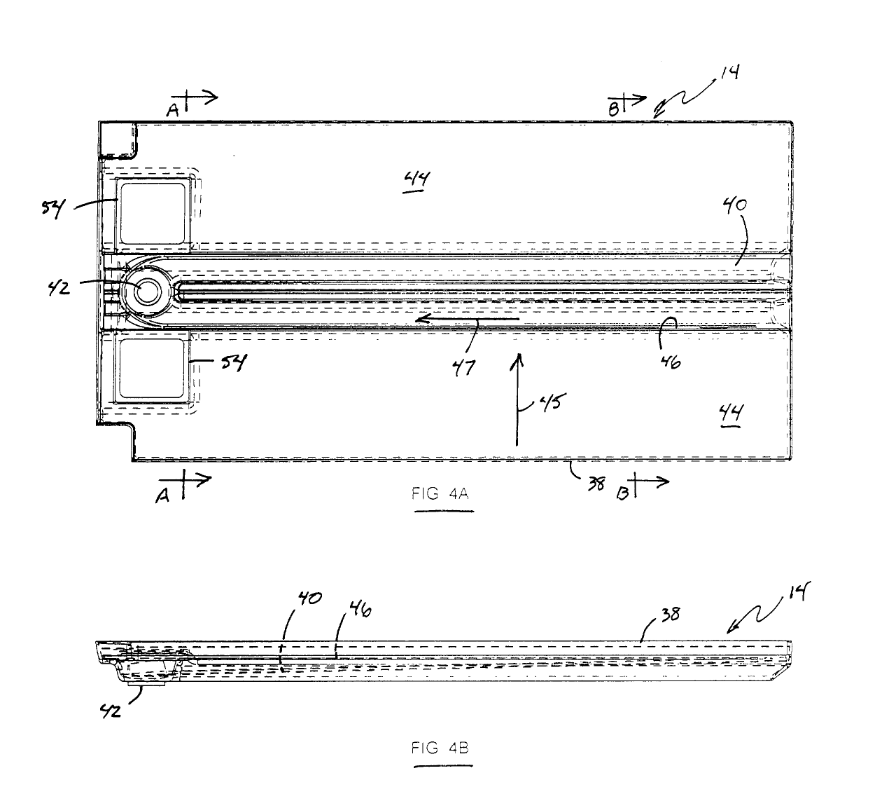

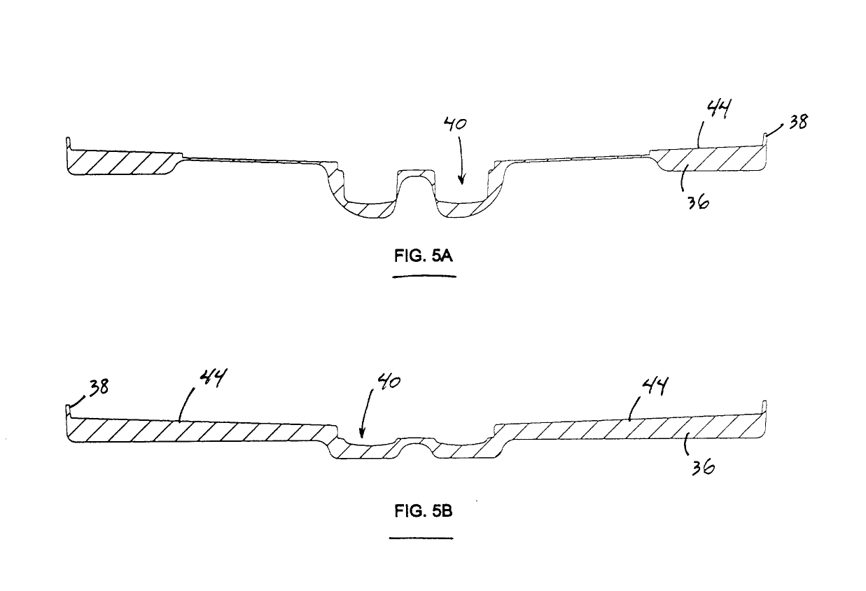

Referring now to FIGS. 4A and 4B and FIGS. 5A and 5B, a preferred embodiment of a floor tub constructed in accordance with the present invention is indicated generally at reference numeral 14. Floor tub 14 is preferably comprised of a material that is durable, stain resistant, resistant to cleaners and bleaches, and resistant to water and fluid penetration such as a plastic or composite material. Floor tub 14 is comprised of a substantially rectangularly-shaped panel 36 having a lip 38 around the edge thereof. Floor tub 14 is provided with a longitudinal gutter 40 running in substantially the same direction as the long dimension of the rectangularly-shaped panel 36 and a drain 42. As best shown in FIG. 4B, the gutter 40 slopes downwardly from one end of panel 36 to the drain 42.

Referring now to FIGS. 5A and 5B, it can be seen that the surface of panel 36 comprising floor tub 14 slopes downwardly from the lip 38 to the gutter 40 as shown at reference numeral 44. In other words, the gutter 40 slopes downwardly in a direction that is substantially parallel to the long dimension of floor tub 14 and the surface of panel 36 on either side of the gutter 40 slopes downwardly from the lip 38 to the gutter 40 in a direction that is substantially perpendicular to the long dimension of the floor tub 14. Those skilled in the art who have the benefit of this disclosure will recognize that the floor tub 14 is formed in various lengths depending upon the sizes of the enclosures that are desired and the size of the space in which the modular kennel system of the present invention is to be erected. For this reason, although the floor tubs 14 are shown and described in a preferred embodiment as being rectangular in shape, floor tubs 14 are also formed with dimensions that are such that the floor tubs are not rectangular. For this reason, the floor tubs 14 are referred to herein as being “substantially” rectangular, it being recognized from this description that the term “rectangular” is being utilized for purposes of providing a convenient point of reference to a long dimension (defined by the direction in which the gutter 40 runs) of the panel 36 of floor tub 14 and that, when the qualifier “substantially” is used with that word, the intention is to describe an inventive element that has a length and a width, regardless of whether the length is greater than the width or vice-versa. By comparison of FIGS. 5A and 5B, it can be seen that the pitch of the downwardly sloped surface 44 of panel 36 is such that there is a drop-off between the sloped surface 44 and the gutter 40 even at the end of panel 36 opposite drain 42 near lip 38. A shoulder 46 is formed at the drop-off between sloped surface 44 and gutter 40 on which a grate 48 (see FIGS. 2 and 3) rests to cover the gutter 40. In the preferred embodiment shown, the dimensions of the grate 48 and the dimensions of the floor tub 14 are sized so that the grates covering the gutter 40 on shoulder 46 can also be used to cover the sloped surface 44 of panel 36 as shown overlying the floor tubs 14A in FIGS. 2 and 3. However, those skilled in the art will also recognize that the present invention is not so limited as to require the use of grates of the specific sizes and arrangements shown herein and that a number of grates are available in a number of different sizes, any one or more of which will provide the desired goal of keeping and animal housed within the enclosure healthy and dry. Although not required, a cover 50 may also provided to close the space between the edges of the grates 48 over gutter 40.

Referring again to FIGS. 1 and 2, it can be seen that the floor tubs 14A and 14B of module 10 are oriented relative to each other so that the drain basins at the low ends of each of the gutters 40 are proximate each other. A drainpipe 52 connects the drains 42 at the low ends of the gutters 40 of the respective floor tubs 14A and 14B and runs between the modules 10A, 10B, etc. so as to connect the drains of each successive module 10A, 10B, etc. comprising the kennel system of the present invention as shown in FIG. 1. In this manner, the enclosures comprising several modules 10A, 10B, etc. are all drained from a single drainpipe 52.

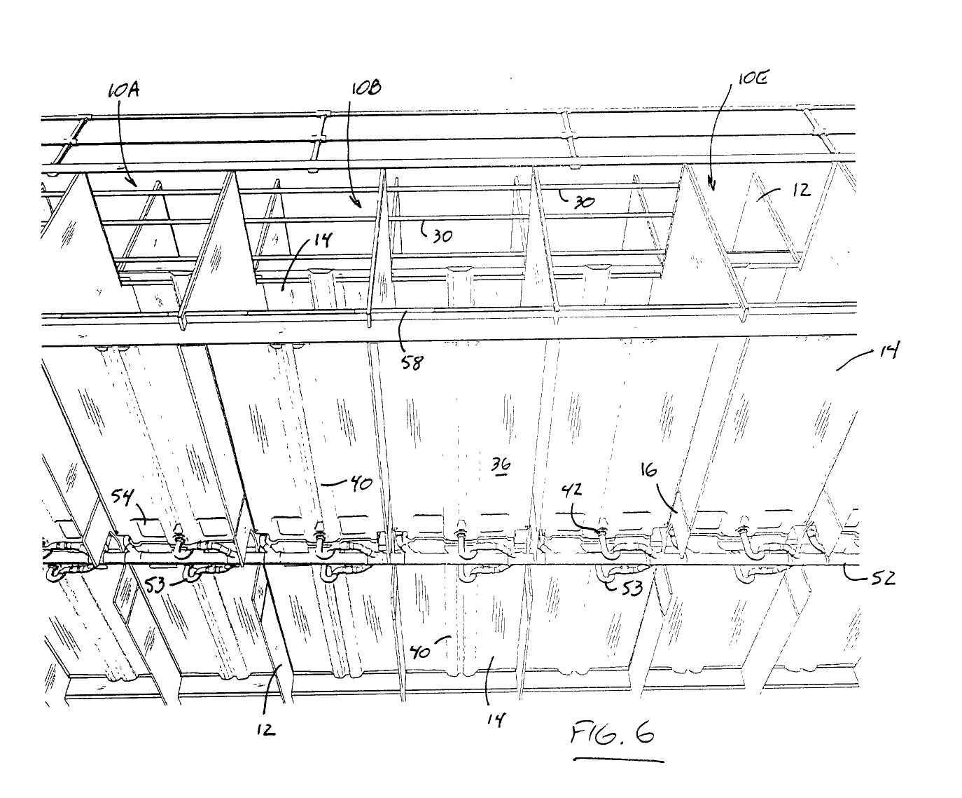

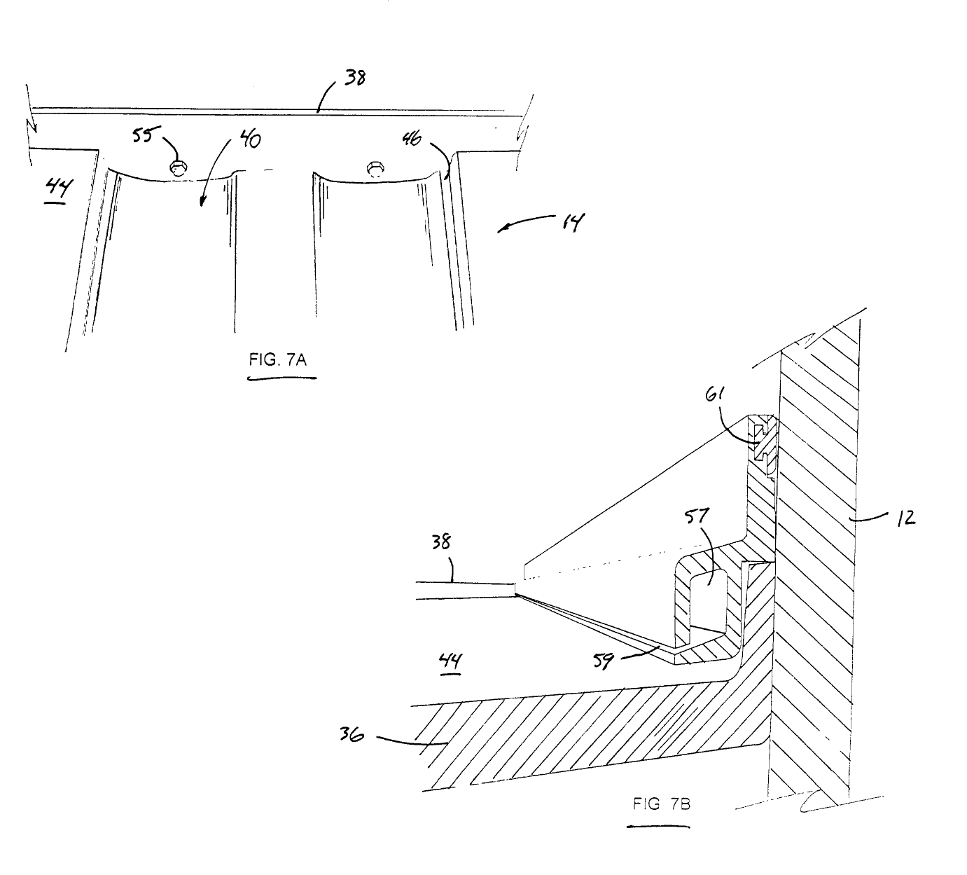

As noted above, the floor tubs 14 are supported from vertical panels 12 at a height above the surface on which the panels 12 rest, and the reason for the space under the floor tubs 14 will now be apparent from this explanation of the manner in which the cages comprising the modules 10A, 10B, etc. are drained. In a particularly preferred embodiment that is best shown in FIG. 6, the space under the floor tubs 14 is tall enough that plumbing traps 53 are incorporated into the connection between the drains 42 and the drainpipe 52 to provide effective protection against cross-contamination, including sewer gases, of the enclosures comprising the modular kennel system of the present invention. The drains 42 and their connections to drainpipe 52, as well as drainpipe 52 itself, are sized so as to be capable of handling waste of even the largest expected size that is washed down from the surface 44 of floor tubs 14 either by spraying with water from a hose (not shown) or by an automatic flush (see the description of the alternative embodiment shown in FIGS. 7A and 7B set out below) that is built into or mounted on the panels 12 above the point at which the lip 38 of each floor tub 14 is secured to the panels 12, both in a manner that is known in the art. Although not shown in FIG. 3 for purposes of clarity, the enclosures comprising the second level of modules 10A, 10B, etc. are drained either from a second drainpipe running across the modules between towers 24 or the drains 42 in the low ends of the gutters 40 comprising the floor tubs 14 of the second level of the modules are connected to a vertical pipe that runs down inside the towers 24 and is also tied into the drainpipe 52.

In a second preferred embodiment shown in FIGS. 7A and 7B, the floor tub 14 of the present invention is provided with one or more nozzles 55 for directing water into the gutter 40 at the high end of floor tub 14 and longitudinal water conduits 57 having a slit opening 59 therein mounted to the lip 38 along the long dimension of the floor tubs 14. Although it is not intended that the invention be so limited, the water conduits 57 are mounted to the lip 38 by resting on the top of lip 38 and securing to the rail 61 that is mounted to the panel 12 (or panel 16, as the case may be). The water supply to the nozzles 55 and water conduits 57 is under manual control or controlled by a timer or conductive switch that senses the accumulation of liquid waste in the gutter 40 or elsewhere in the plumbing system of the present invention to switch the water on to flush each of the surface 44 of the tub floors 14 comprising each of the enclosures comprising the modular kennel system of the present invention. The switches can be set to flush simultaneously or separately as needed to maximize the flushing action of the water.

As will be apparent from this description of this preferred embodiment of the present invention, it is particularly advantageous that the flushing of wastes that may be accumulated on the surface 44 by such a system is accomplished over a relatively short dimension, e.g., from the edge of panel 36 to the longitudinal gutter 40 in the direction of arrow 45 on FIG. 4A, thereby maximizing the flushing action of the water while minimizing water usage. Of course the water that is flushed over the surface 44 in the direction of arrow 45 accumulates in the longitudinal gutter 40, and gutter 40 is deep enough and provided with enough of a slope that the accumulated water and waste moves down the sloping gutter to the drain 42 at the low end thereof in the direction of arrow 47 by gravitational action. As noted above, however, the gutter 40 may also be provided with the nozzles 55 for improved flushing rather than relying solely on the force of gravity on the water used to flush the tub surface 44 to move the accumulated waste out of the enclosure. Although it does not eliminate the need for manual clean-up of solid waste, this system enables the animal confined in the enclosure to remain healthy and dry on top of the grates 48 while providing effective flushing of the enclosures with minimal manual labor.

Although not necessary to the function of the kennel system of the present invention, in the embodiment shown in FIGS. 2 and 3 each module 10A, 10B, etc. is provided with a step 58 that is also supported by straps 30 that rest on a rail 34 that is secured to the substantially vertical panels 12. To give a finished look and to close off the opening under the step 58, a recessed toe kick 60 is preferably provided on the front of step 58. Those skilled in the art will also recognize that the stairway 62 (FIG. 1) to the second level of cages is constructed in one of the modules 10 of the kennel system of the present invention by supporting multiple steps 58, with toe kicks 60 between steps 58, from rails and straps (not shown in FIG. 1) secured to the panels 12. Alternatively, the module is provided with a purpose-built staircase. As shown in FIGS. 2 and 4A, the floor tubs 14 may also be provided with utility panels 54 for covering the openings 56 in the floor of each of the cages comprising the modules 10A, 10B, etc. for servicing the connections between the drains 42 and drainpipe 52.

Construction of the modular kennel system of the present invention, as well as the flexibility in placement and/or re-location of the system, is greatly facilitated by the use of a minimum number of parts that are either used as provided or cut to fit on site. For instance, the forming of the floor tubs 14 to size allows construction of a kennel system of a size that is optimized for the largest possible number of enclosures in the space that is available for construction of the modular kennel system. Note also that enclosures of different sizes can be constructed within the same kennel system, allowing for the housing of animals of different sizes, by forming the floor tubs 14 to different lengths. Similarly, the use of the divider doors 26 also creates the opportunity for enclosures of different sizes for housing animals of different sizes. Note also that although a preferred embodiment of the modular kennel system of the present invention is described and shown as being comprised of a module that comprises two floor tubs with the drains of the floor tubs being proximate each other, there is no requirement that the kennel system of the present invention must be erected in this manner. Instead, this particular embodiment is merely one embodiment of the present invention and the claims that are appended hereto that define the invention in terms of a module that comprises two floor tubs with a drainpipe that connects adjacent modules is but one way to define the invention. The floor tubs of the present invention are also utilized to advantage in a single row of enclosures with a drainpipe that connects one floor tub to an adjacent floor tub (instead of two floor tubs with their drains approximated as shown in FIGS. 2 and 3) and so on in a single row of enclosures instead of row of enclosures that are “two deep.”

Ventilation of the enclosures comprising the modular kennel system of the present invention is facilitated by the use of the above-described grill 20 and door 22 and by the use of screens 64 (see FIG. 2) at the top of the vertical panels 12. Of course those skilled in the art will recognize that it in cold climates, additional air circulation may be undesirable, so the screens may also be omitted (as in FIG. 3) and the grills 20 and doors 22 may be replaced by solid panels and/or safety glass. Although the design of the modular kennel system of the present invention is such that it generally is not necessary, additional air circulation can also be achieved by circulating air through a low-pressure air plumbing system (not shown) running through the space above the surface on which the modular kennel system of the present invention rests and under the floor tubs 14, and up into each module 10A, 10B, etc. through the towers 24. It will also be recognized by those skilled in the art that a low-pressure air plumbing system of this type provides the opportunity for circulating air, or for circulating cooled or heated air in warm or cold climates. Alternatively, resistive heating elements may be placed in the space between the surface on which the panels 12 rest and the underside of the floor tubs 14 for heating the floor of each enclosure and/or radiant heaters are incorporated into the modular kennel system of the present invention, for instance, in the towers 24.

Those skilled in the art who have the benefit of this disclosure will recognize that certain changes can be made to the component parts of the modular kennel system of the present invention without changing the manner in which those parts function to achieve their intended result. For instance, the step 58 is not an essential element of the invention and may be omitted for the purpose of increasing the size of the enclosures. Similarly, the floor tubs 14 on either side of the modules 10A, 10B, etc. need not be the same length such that each module may be comprised of enclosures of different sizes. The present invention also contemplates that the divider door 26 dividing each module 10A, 10B, etc. into two enclosures may be replaced by a solid panel or a guillotine-type door without compromising the desired goals of flexibility and ease of construction. It will also be apparent that the enclosures comprising the modular kennel system of the present invention may be provided with drop-down resting shelves of a type known in the art so that the animal can avoid sleeping on the floor of the enclosure. Another modification that provides additional flexibility to the modular kennel system of the present invention is the inclusion of a storage bin, or locker (for instance, for storage of the animal's toys, medication, food, and/or bedding) that is accessible only from the outside of the enclosure forming the modular kennel system of the present invention that is located in the door 22 of the enclosure. Those skilled in the art will also recognize that there are many ways that the horizontal elements of the modular kennel system of the present invention can be supported from the vertical panels 12 other than by the rails 34 and straps 30, 32.

Another example of a change that is also intended to fall within the scope of the following claims is the use of floor tubs 14 that are themselves formed with grates such that the grates 48 are not necessary. Those skilled in the art will recognize that, in such a system, it would be necessary to position sloped pans (not shown) that drain into a center trough under the floor tubs 14. However, because the modular kennel system of the present invention is, so far as is known, the first kennel system that includes a flush system that can be erected without modifying the building on which it is erected, it offers the opportunity for such an “under floor tub” flush system. Other such changes might include the addition of a third level of cages. All such changes, and others that will no doubt be made clear to those skilled in the art by this description of the preferred embodiments, are intended to fall within the scope of the following, non-limiting claims.

What is claimed is:

1. A floor tub for an animal cage comprising:
a substantially rectangular panel;
a lip formed around the edge of said panel;
a gutter formed in the surface of said panel and running in the direction of the long dimension thereof, said gutter being deeper at one end of said panel than the other end; and
the surface of said panel in which said gutter is formed being sloped downwardly from said lip to said gutter.

2. The floor tub of claim 1 additionally comprising a drain located at the low end of said gutter.

3. The floor tub of claim 1 additionally comprising a recess for receiving a grate for covering said gutter.

4. The floor tub of claim 3 wherein said panel is sized so that a plurality of grates of the same size and shape as said recess can be arranged so as to cover the surface of said panel.

5. A modular kennel system comprising:
at least two modules, each of said modules comprising:
a pair of substantially vertical panels,
a pair of substantially horizontal, substantially rectangular floor tubs, each of said floor tubs being supported from a respective panel,
each of said floor tubs having a gutter formed therein that slopes from one end of said floor tub to the other end of said floor tub, said floor tubs being oriented relative to each other so that the low ends of each of the gutters are proximate each other; and
a drain pipe running between each of said modules to which the low ends of the gutters in each of the floor tubs comprising said modules are connected.

6. The modular kennel system of claim 5 additionally comprising a divider for separating said module into two enclosures.

7. The modular kennel system of claim 5 wherein said floor tub slopes from the edges thereof downwardly to the gutter formed therein.

8. The modular kennel system of claim 7 additionally comprising a water conduit mounted to said floor tubs along said vertical panels for flushing the surface of said floor tub into the gutter formed therein.

9. The modular kennel system of claim 8 additionally comprising a water nozzle at the high end of the gutter for flushing the gutter into said drainpipe.

10. The modular kennel system of claim 5 additionally comprising a plumbing trap in the connection between the drain of each of said floor tubs and said drainpipe.

11. The modular kennel system of claim 5 additionally comprising a second level of enclosures formed in each of said modules.

12. The modular kennel system of claim 5 additionally comprising a utility panel formed in said floor tub.
